(19) United States
(12) Patent Application Publication
(10) Pub. No.: US 2014/0380246 A1
(43) Pub. Date: Dec. 25, 2014

(54) SYSTEMS AND METHODS FOR MULTI-LAYER USER CONTENT NAVIGATION

(71) Applicants: David BLUNDELL, San Francisco, CA (US); Steffen HOFFMAN, Santa Monica, CA (US); Anil NARASIPURAM, Palo Alto, CA (US); Tessa PETRICH, San Francisco, CA (US)

(72) Inventors: David BLUNDELL, San Francisco, CA (US); Steffen HOFFMAN, Santa Monica, CA (US); Anil NARASIPURAM, Palo Alto, CA (US); Tessa PETRICH, San Francisco, CA (US)

(73) Assignee: AOL INC., Dulles, VA (US)

(21) Appl. No.: 13/925,292

(22) Filed: Jun. 24, 2013

(51) Int. Cl. G06F 3/0484

(52) U.S. Cl. CPC G06F 3/0484
USPC 715/854

(57) ABSTRACT

Systems and methods are disclosed for providing navigation control across multiple layers of content views within a mobile application. One method includes: providing a first layer of content views that are each selectable by a user for display via a graphical user interface of an application executable at a mobile device; responsive to receiving user input selecting at least one of the content views in the first layer, obtaining content views for a second layer corresponding to the content view selected in the first layer; and enabling the user to navigate between the content views in the first layer and corresponding content views in the second layer via the graphical user interface; wherein content views obtained for the second layer are automatically updated with content views corresponding to a currently selected content view in the first layer.

### TECHNICAL FIELD

The present disclosure relates generally to graphical user interfaces for navigating content applications and, more particularly, to control elements for navigating between different content views via a graphical user interface of a device, such as within a mobile application.

### BACKGROUND

Mobile devices, such as smartphones, allow users to perform various types of tasks using specialized applications executing at their respective devices. Such a mobile application may be used, for example, to share content and data related to a topic of interest between different mobile device users. A mobile application typically has a graphical user interface (GUI) including control elements, with which a user can interact for invoking different functions provided by the mobile application. Such functions may include, for example, navigating between different views of content displayed at the mobile device by interacting with the GUI's control elements via a touch-screen display or other type of user input device of the mobile device.

In particular, the navigation functionality provided by a mobile application through its GUI generally depends upon the type of navigation scheme used to control transitions between the different content views that may be displayed at the device based on user input. Conventional navigation schemes typically include a navigation bar at the top of the screen for providing elements for moving forward and backward through content screens. The navigation bar may include a number of control elements for providing the user with descriptive information (e.g., a title) related to the particular content view being displayed currently along with options for navigating from the current view to a different content view.

However, the available options provided to a user by such conventional navigation control schemes are generally limited to a predefined navigation path between different content views. As such, the user may only be able to move between different views in a linear direction, e.g., back and forth between consecutive views within a set of content views stacked together in a predefined order. That is, the user can choose different paths to move forward from a single screen to the next, but then the user always returns through the same screens. Furthermore, as such navigation schemes are generally restricted to a single context or navigation flow between content views for an individual application function, or for each set of functions or context of the application, multiple contexts or separate instances of the same navigational flow may be required in order to support different functions of the mobile application.

### SUMMARY OF THE DISCLOSURE

Embodiments disclose systems and methods for providing user navigation control across multiple layers of content views displayed via a graphical user interface of a mobile application.

According to certain embodiments, methods are disclosed for providing navigation control across multiple layers of content views within a mobile application. One method includes: providing a first layer of content views that are each selectable by a user for display via a graphical user interface of an application executable at a mobile device; responsive to receiving user input selecting at least one of the content views in the first layer, obtaining content views for a second layer corresponding to the content view selected in the first layer; and enabling the user to navigate between the content views in the first layer and corresponding content views in the second layer via the graphical user interface; wherein the user selects different content views in the first layer or the second layer to be displayed at the mobile device via the graphical user interface, and content views obtained for the second layer are automatically updated with content views corresponding to a currently selected content view in the first layer.

According to certain embodiments, systems are disclosed for providing navigation control across multiple layers of content views within a mobile application. One system includes a data storage device storing instructions for providing navigation control across multiple layers of content views within a mobile application; and a processor configured to execute the instructions to perform a method including: providing a first layer of content views that are each selectable by a user for display via a graphical user interface of an application executable at a mobile device; responsive to receiving user input selecting at least one of the content views in the first layer, obtaining content views for a second layer corresponding to the content view selected in the first layer; and enabling the user to navigate between the content views in the first layer and corresponding content views in the second layer via the graphical user interface; wherein the user selects different content views in the first layer or the second layer to be displayed at the mobile device via the graphical user interface, and content views obtained for the second layer are automatically updated with content views corresponding to a currently selected content view in the first layer.

According to certain embodiments, a computer readable medium is disclosed as storing instructions that, when executed by a computer, cause the computer to perform a method of providing navigation control across multiple layers of content views within a mobile application, the method including: providing a first layer of content views that are each selectable by a user for display via a graphical user interface of an application executable at a mobile device; responsive to receiving user input selecting at least one of the content views in the first layer, obtaining content views for a second layer corresponding to the content view selected in the first layer; and enabling the user to navigate between the content views in the first layer and corresponding content views in the second layer via the graphical user interface; wherein the user selects different content views in the first layer or the second layer to be displayed at the mobile device via the graphical user interface, and content views obtained for the second layer are automatically updated with content views corresponding to a currently selected content view in the first layer.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the scope of disclosed embodiments, as set forth by the claims.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram of an exemplary network environment suitable for practicing an embodiment of the present disclosure;

FIG. 2 is a flow diagram of an exemplary navigation control scheme for providing navigation control across multiple layers of content views via a graphical user interface of a mobile application;

FIG. 3 is a flow diagram of an exemplary process and navigation control scheme for providing navigation control across multiple layers of content views via a graphical user interface according to the navigation control scheme of FIG. 2;

FIGS. 4A-4C illustrate exemplary content views for a foreground layer of navigation control provided via a graphical user interface based on the navigation control schemes of FIGS. 2 and/or 3;

FIG. 5 illustrates an exemplary content view for a create screen or background layer of navigation control provided via a graphical user interface based on the navigation control schemes of FIGS. 2 and/or 3;

FIG. 6 is a process flow diagram of an exemplary method for providing navigation control across multiple layers of content views displayed via a graphical user interface of a mobile device application; and

FIG. 7 is a block diagram of an exemplary computer system in which embodiments of the present disclosure may be implemented.

### DESCRIPTION OF THE EMBODIMENTS

The present disclosure is directed to overcoming one or more of the above referenced issues. Specifically, the present disclosure is directed to systems and methods for navigating between different content views via a graphical user interface of a device, such as within a mobile application. Reference will now be made in detail to the exemplary embodiments of the disclosure, examples of which are illustrated in the accompanying drawings. Wherever possible, the same reference numbers will be used throughout the drawings to refer to the same or like parts.

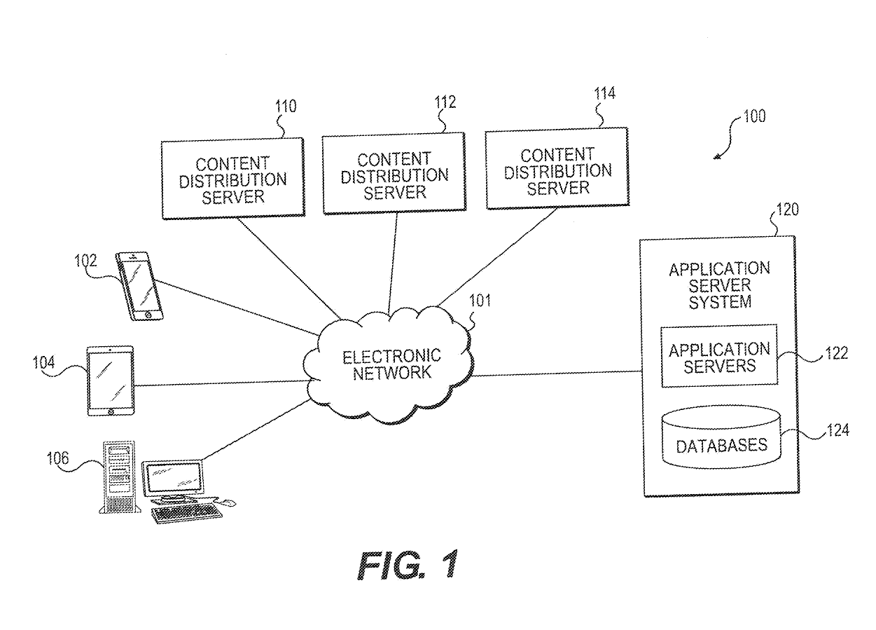

The present disclosure relates to systems and methods for providing navigation control across multiple layers of content views that may be displayed via a graphical user interface (GUI) of an application executable at a computing device. For example, the present disclosure enables a user of such an application to navigate through multiple “layers” of content views, such as a “top” layer and a “bottom” layer, which can interact with each other in meaningful ways to enhance the user experience. In one embodiment, the computing device is a mobile device and the application is a client application executable at the mobile device. The client application in this example may be any type of mobile application executable at the mobile device for providing different functionality for a user of the mobile device. The GUI of the client application may include different control elements with which the user may interact to invoke various functions provided by the application. Such functions may include, for example and without limitation, sending stored content and data from the user's mobile device or requesting to receive content and data to or from other computing devices through a communication network, as will be described in further detail below with respect to the exemplary network environment of FIG. 1.

Also, as will be described in further detail below, the GUI of the client application executable at the user's device may be used to implement a multi-layer navigation control scheme providing navigation control across multiple layers of content views. In an example, the multiple layers of the navigation control scheme include at least one foreground layer of content views and at least one background layer including multiple sets of content views. In one embodiment, each set of content views of the background layer in this example may correspond to a particular content view in the foreground layer. For example, each of the content views in the foreground layer may correspond to different content categories. Examples of different content categories may include, but are not limited to, different geographic locations, such as different cities or towns within a state or other large geographic territory within a country. Alternatively, each of the content views in the foreground layer may correspond to different subject matter categories, such as sports, news, politics, celebrities, and so on. In yet another embodiment, each of the content views in the foreground layer may correspond to one of a plurality of different users within a group of users, and so on.

In one embodiment, content views in the foreground layer may correspond to a different content categories. The foreground layer may also include a catalog view providing a listing of available content categories and related content views, which may be selected by a user for display via a GUI of the client application. Such a catalog view of content categories and foreground views may be presented to the user as, for example, a home screen for the client application, which may be displayed at the user's device when the application is first launched. In a further embodiment, the available content views of the foreground layer may be presented in the catalog view or home screen as different content items with graphic and text, which the user can view and manipulate within a content viewing area of the GUI. In some implementations, the content items corresponding to available foreground views may be provided within a dedicated content viewer integrated with the GUI of the client application executable at the user's device. The GUI in this example allows the user to select different content items corresponding to the particular content views that the user would like to have displayed at the device. As will be described in further detail below, the GUI also allows the user to navigate between the currently displayed foreground view, as selected by the user, and content views in a background layer. Such background views may include additional content related to the content displayed in the current foreground view. In an embodiment, the background views may be inactive or active and in a “hidden” state for the view being displayed currently.

The terms “navigate,” “navigation” and other variants of these terms are used herein to refer to the change or transition a current view of content, as currently displayed for a user via a display of the user's computing device, to one or more different content views. As described above, a GUI of an application executable at the user's device may include different navigation controls enabling the user to select and navigate between different content views. As will be described in further detail below, the change in view may include, for example, transitioning between different content views across multiple layers. A separate navigation controller may be provided for controlling navigation between different content views in a single layer. Accordingly, the term “navigation layer” may be used herein to refer to a layer of content views. Additionally, a main or primary navigation controller may be implemented for automatically providing navigation control when transitioning between different content views across multiple navigation layers.

FIG. 1 is a schematic diagram of an exemplary network environment 100 suitable for practicing an embodiment of the present disclosure. As shown in FIG. 1, network environment 100 may include user devices 102, 104 and 106, content distribution servers 110, 112 and 114, and an application server system 120, all of which may be communicatively coupled via electronic network 101. Network 101 may be any type of electronic network or combination of networks used for communicating digital content and data between various computing devices. Network 101 may be, for example, a local area network, a medium area network, or a wide area network, such as the Internet. While only user devices 102, 104 and 106 and content distribution servers 110, 112 and 114 are shown in FIG. 1, it should be understood that network environment 100 may include additional user devices and content distribution servers.

As shown in FIG. 1, server system 120 includes one or more application servers 122 coupled to one or more databases 124. Databases 124 may be used to store any type of data or content (e.g., text or media content) accessible by application servers 122. In an example, application servers 122 host a web service or application that communicates with a client application executable at each of user devices 102, 104 and 106 via network 101. The respective users of devices 102, 104, and 106 may access different functions provided by the web service via a GUI of the client application. Such functions may include, for example and without limitation, uploading user-generated content to a web site or content repository for later access and retrieval or alternatively, requesting content from other users or third-party content providers, which may be downloaded to the user's device through an application interface provided by the application server system 120.

User devices 102, 104, 106 may be any type of electronic device configured to send and receive data, such as websites, multimedia content, and electronic advertisements, over electronic network 101. In the example shown in FIG. 1, user device 102 may be a mobile device, smartphone, and/or personal digital assistant (“PDA”), user device 104 may be a tablet device or other type of mobile computing device having a touchscreen display, and user device 106 may be a desktop, laptop, or other type of personal computer. As noted above, each of user devices 102, 104, 106 may be configured to execute a client application installed at the device. The client application at each device may be used for receiving and displaying electronic content from application server system 120 and/or one or more of content distribution servers 110, 112 and 114. In one embodiment, the client application is a web browser that is executable at each of the user devices 102, 104 and 106. Alternatively, the client application is a mobile application.

In one embodiment, user devices 102, 104, 106 may be configured to download the client application and/or application content through an interface provided by application server(s) 122 of application server system 120 over network 101. In one embodiment, user devices 102, 104, 106 may be configured to download content from requested by a user at each device based on input received from the user via a GUI of the client application.

In an example, application servers 122 may be configured to communicate with one or more of content distribution servers 110, 112 and 114 to retrieve the content requested by the user via the GUI of the client application executable at the user's device (e.g., user device 102). Application servers 122 in this example may be configured to first check whether or not the requested content is stored within databases 124 prior to requesting the content from any content distribution servers. Alternatively, the client application executable at the user's device may be configured to communicate directly with content distribution servers 110, 112 and 114 for requesting relevant content via network 101.

Content distribution servers 110, 112 and 114 may be owned and/or operated by any entities that publish online or electronic content. For example, content distribution servers 110, 112 and 114 may be operated by publishers, such as online content providers, search engines, e-mail programs, RSS feed providers, magazines, e-zines, blogs, or any other online site or program that distributes online content. Thus, publishers may interact with user devices 102, 104, 106, DNS servers, ad servers, content distribution network servers, or any other servers through one or more of content distribution servers 110, 112 and 114 via network 101. Thus, publishers may be able to distribute electronic content to various entities located within the network environment 100 of FIG. 1. In one embodiment, each of the application servers 120 or third-party content distribution servers 110, 112, 114 may provide, for example, an interface (e.g., in the form of an application programming interface (API)) for enabling communications between a particular service or application hosted at each of the servers and the client application executable at the user's computing device. The particular service in this example may be a content distribution service configured to respond to requests (e.g., content retrieval requests) received from the client application via the communication network.

As will be described in further detail below, the GUI of the client application executable at each of user devices 102, 104 and 106 may be configured to display the downloaded content via a content navigation control, across multiple layers of content views, via the GUI. As will be described in further detail below, the GUI of the client application may include, for example, various control elements enabling the user to browse different content views within a foreground layer or navigate between content views of the foreground layer and different content views in a background layer. The content views of the background layer in this example may include content that is related to a particular content view in the foreground layer, as selected by the user via the GUI of the client application.

Any of user devices 102, 104, 106, content distribution servers 110, 112, 114, and application server system 120, including application servers 122, may be implemented using, for example, any one or combination of various computing systems. Examples of such computing devices include, but are not limited to, handheld devices, personal computers, servers, clustered computing machines, and/or cloud computing systems. In one embodiment, each of user devices 102, 104, 106, content distribution servers 110, 112, 114, and application server system 120, may be an assembly of hardware, including a memory, a central processing unit (“CPU”), and/or optionally a user interface. The memory may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. The CPU may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software. The user interface may include any type or combination of input/output devices, such as a display monitor, touchpad, touchscreen, microphone, camera, keyboard, and/or mouse.

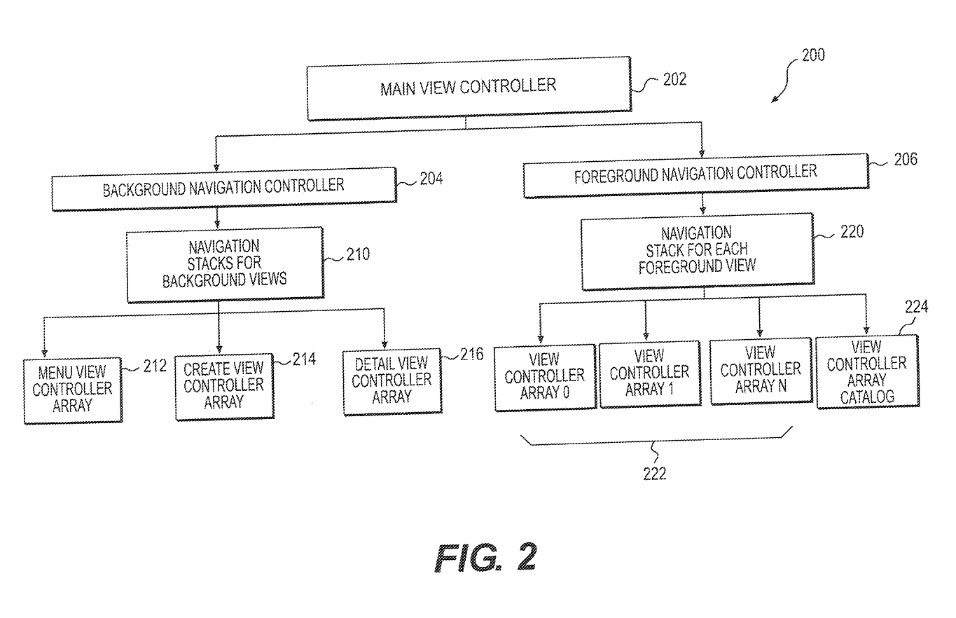

FIG. 2 is a flow diagram of an exemplary navigation control scheme 200 for providing navigation control across multiple layers of content views via a graphical user interface of a mobile application executable at an electronic device (e.g., user devices 102, 104, 106 of FIG. 1, as described above). In the example shown in FIG. 2, the multiple layers of content views may include a foreground layer of content views and a background layer of content views corresponding to each of the content views in the foreground layer. However, it should be noted that additional layers of content views may be used as desired for a particular implementation.

Accordingly, as shown in FIG. 2, navigation control scheme 200 may include a main view controller 202, a background navigation controller 204, and a foreground navigation controller 206. In this example, foreground navigation controller 206 may manage a set of content views (or “navigation stack”) 220 for the foreground layer, while background navigation controller 204 may manage a different set of content views (or “navigation stack”) 210 in the background layer, with each set of content views in the background layer corresponding to each content view in the first layer. In one embodiment, the main view navigation controller 202 may be a parent controller to background and foreground navigation controllers 204, 206: and background and foreground navigation controllers 204, 206 may be child controllers to main view navigation controller 202.

As shown in FIG. 2, the navigation stacks 210 may be distributed between different view controller arrays 212, 214, and 216, which may be separate navigation stacks that may be stored, for example, at a memory of the computing device, and alternately used, as desired. In one embodiment, a menu view controller array 212 may be displayed in response to user selection of a menu icon. For example, a user may manipulate such a menu icon to access a menu view, and/or to display a menu including elements of the menu view controller array 212 displayed within a foreground view according to a predetermined method, such as by pulling or dragging a foreground view downward. The background navigation controller 204 may push background view controllers or arrays that have no associated foregrounds onto a menu view controller navigation stack of the menu view controller array 212; and/or may push foreground view controllers optionally having associated detailed background view controllers onto a foreground navigation stack 220, e.g., within one of a plurality of view controller arrays 222, and a detailed background navigation stack. As a result, one or more view controllers of the foreground navigation stack 220 may have a view controller pushed from menu view controller array 212. In one embodiment, a create view controller array 214 may be displayed in response to the user's manipulation of a wheel element configured to display a foreground navigation stack 220 for creating content to be uploaded to a content distribution service, e.g., hosted at one of content distribution servers 110, 112 or 114 of FIG. 1, as described above, via a communication network, e.g., network 101 of FIG. 1. In one embodiment, when a user taps the displayed wheel element, the appropriate content creation navigation stack selected from the set of foreground navigation stacks 220 distributed between view controller arrays 224 may be displayed via the GUI of the client application executable at the user's device. When the user taps a “Cancel” icon or again taps the displayed wheel element, the corresponding foreground navigation controller array or view may be displayed. In one embodiment, a detail view controller array 216 may be configured to generate a display of detailed information or user elements in a background view. For example, one or more foreground views may have additional information to be presented in a background view behind a respective foreground view, in which case detail view controller array 216 may replace a previously displayed background view with a new, detailed background view.

Also as shown in FIG. 2, in one embodiment, navigation stack 220 may include a plurality of view controller arrays 222 for view controllers 0-N. Specifically, as discussed above, the presently disclosed foreground navigation controller 206 may be configured to present multiple foreground views, with each foreground view corresponding to a particular location (e.g., city, township, venue, country, etc.), subject matter topic, person, etc. Thus, each view controller array 222 may be configured to generate a display of content views corresponding to each of the plurality of content categories. In one embodiment, the navigation stack 220 may be configured to generate a display of foreground views, each perceived by the user as being positioned side-by-side, through which a user may drag or swipe, left and/or right, to advance left and/or right through the displayed foreground views.

Further, background navigation controller 204 and foreground navigation controller 206 may be configured to provide navigation control only between different content views in the background layer or foreground layer, respectively. Thus, main view controller 202 may be configured to coordinate with both background navigation controller 204 and foreground navigation controller 206 in order to provide navigation control between different content views across the foreground and background layers. However, notwithstanding involvement of main view controller 202, one or both of background navigation controller 204 and foreground navigation controller 206 may communicate with each other, such as by communicating user inputs, current view, current user element dimensions or inputs, displayed content types, selected array, operating view controller array, and so on. However, in one exemplary embodiment, the foreground navigation controller 206 may communicate status information and/or content to background navigation controller 204, whereas the background navigation controller 204 does not communicate status information and/or content to the foreground navigation controller 206.

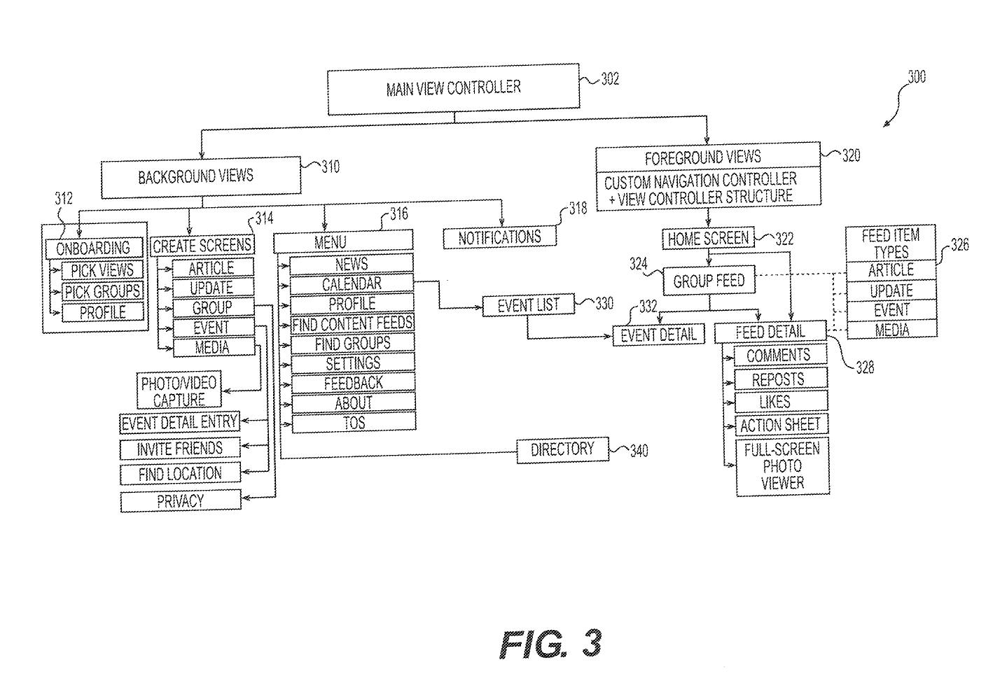

FIG. 3 is a flow diagram of an exemplary control scheme 300 for controlling navigation between multiple layers of content views based on user interaction with various control elements of a GUI of a client application executable at the user's device. In one embodiment, the user's device is a mobile device (e.g., user device 102 of environment 100 of FIG. 1, as described above), and the client application may be a mobile application executable at the mobile device. However, it should be noted that control scheme 300 is not intended to be limited to mobile devices and that control scheme 300 may be implemented for any type of computing device including, but not limited to, a desktop or personal computer. The GUI of the mobile application in this example may include a content viewer or content viewing area for displaying different content views, as selected by the user. Further, the GUI may include various user control elements allowing the user to interact with the content viewer for navigating from a currently displayed content view to different content views across multiple layers of content views.

In one example, the multiple layers include a background layer of content views and a foreground layer of content views. As shown in FIG. 3, control scheme 300 includes a main view controller 302 for controlling navigation between background views 310 and foreground views 320. As will be described in further detail below, the background views 310 may include different sets of content views corresponding to each foreground view 320. It should be appreciated that main view controller 302 may be a type or implementation of main view controller 202 and its related discussion with respect to FIG. 2. Likewise, background views 310 may be generated and controlled by a type or implementation of the background navigation controller 204 and its related discussion with respect to FIG. 2. Also, foreground views 320 may be generated and controlled by a type or implementation of the foreground navigation controller 206 and its related discussion with respect to FIG. 2.

Main view controller 302 may be configured to receive user input based on the user's interaction with particular control elements of the GUI. Such user input may be received from a user input device coupled to the mobile device. Examples of such a user input device include, but are not limited to, a mouse, a joystick, a game controller, a QWERTY keyboard, touch-screen, microphone, a T9 keyboard, or any other user input device. Main view controller 302 may be configured to receive the user input and vary the currently displayed content view or a position of the content view, as displayed on the screen of the mobile device.

In another embodiment, some user control elements of the GUI may be provided as part of the navigation control between different background views 310 while other user control elements may be provided as part of the navigation control for different foreground views 320. As shown in FIG. 3, user control elements for navigation between background views 310 may include, for example and without limitation, user control elements for content views 312 related to onboarding, screen elements 314 for creating new screens for different types of content, menu controls 316, notifications 318, an event list 330, and control elements related to a user directory 340. The content views 312 for onboarding may include elements enabling a user to “Pick Views,” “Pick Groups,” and/or edit a “Profile.” The screen elements 314 for creating new screens may include elements enabling a user to create an “Article,” “Update,” “Group,” “Event,” “Photo,” and/or “Media.” Upon selecting “Photo” or “Media,” a user may select a user element to initiate, for example, a “Photo/Video Capture” to capture a digital image or video using an integrated digital camera of the user's device and/or upload a previously captured image or video to a content distribution service, e.g., via application server system 120 or any of content distribution servers 110, 112, or 114 of FIG. 1, as described above. Upon selecting “Event,” a user may select an element to make an “Event Detail Entry,” initiate a search to “Find Friends,” and/or initiate a search to “Find Location.” Upon selecting “Group,” a user may select a user element to change “Privacy” settings. The menu controls 316 may include user elements enabling a user to view content views and/or menus relating to “News,” “Calendar,” a user's “Profile,” a search to “Find Content Feeds,” a search to “Find Groups,” “Settings,” “Feedback,” view an “About” page, and/or view a “TOS” (terms of service).

User control elements used for navigation between different foreground views 320 include, for example and without limitation, elements for a home screen 322 (e.g., an introductory page or content view), elements for a discussion group feed 324 and related elements 326 and 328 for different feed items and feed details, respectively. Specifically, feed item types 326 may include elements that a user may select to initiate creation of an “Article,” “Update,” “Event,” “Photo,” and/or “Media,” as described above. Feed detail elements 328 may include elements that a user may select to initiate creation of “Comments,” “Reposts,” “Likes,” “Action Sheets,” and/or to view a “Full-Screen Photo Viewer.”

In one embodiment, each of user control elements 312, 314, 316, 318, 330 and 340 may relate to different navigation stacks or sets of background views 310, where each navigation stack or set of background views 310 corresponds to one of the foreground views 320. For example, control elements for event list 330 may relate to a navigation stack or set of background views 310 corresponding to a content view for event detail 332 within foreground views 320. As described above, the navigation control provided for background views 310 may be implemented as navigation stacks 210 using, for example, background navigation controller 204 of FIG. 2, as described above. Similarly, the navigation control provided for foreground views 320 may be implemented as navigation stacks 220 using, for example, foreground navigation controller 220 of FIG. 2, as described above. Advantageously, by using a background navigation controller 204 for managing and controlling the background view navigation stacks 210, and a foreground navigation controller 206 for managing and controlling the foreground view navigation stacks 220, each controller may manage the state management (i.e., memory of displayed view, status of view edge states, etc.). Moreover, the foreground navigation controller 206 may control the displayed foreground view based on inputs received from the background navigation controller 204, and the background navigation controller 204 may control the displayed background view based on inputs received from the foreground navigation controller 206.

In one embodiment, the navigation controller for foreground views 320 may include a custom navigation controller for providing navigation control between various custom views based on user input received through various user control elements associated with custom views. For example, in one embodiment, the various user control elements may include one or more of: a “Jog Wheel,” a “Views” icon, a “Calendar” icon, a “Navigation Bar,” a “Social Network Tray,” an “Avatar Image Mask,” an “Avatar List Cell,” a “3 Way Event Response Slider,” a “Photo/Video Slider,” one or more “Action Sheets,” a “Photo/Video Slider,” a “Full-Screen Photo Viewer,” a “Directory Map View,” and/or a “Page Curl” element.

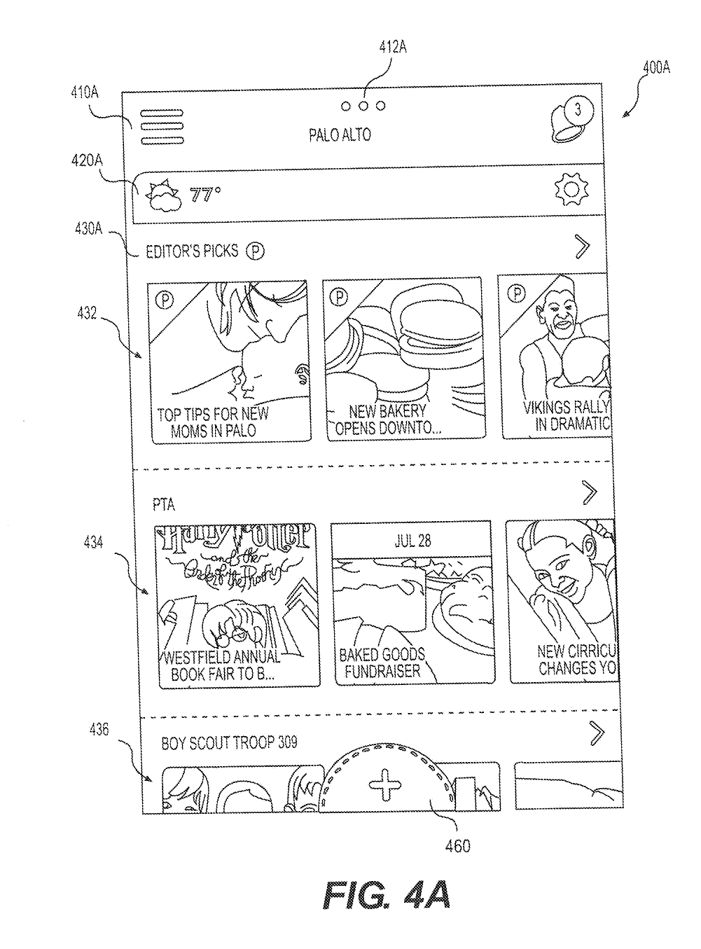

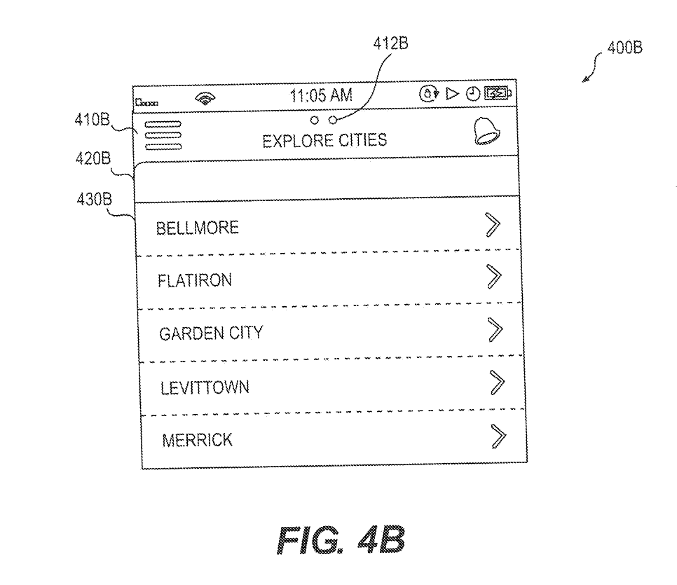

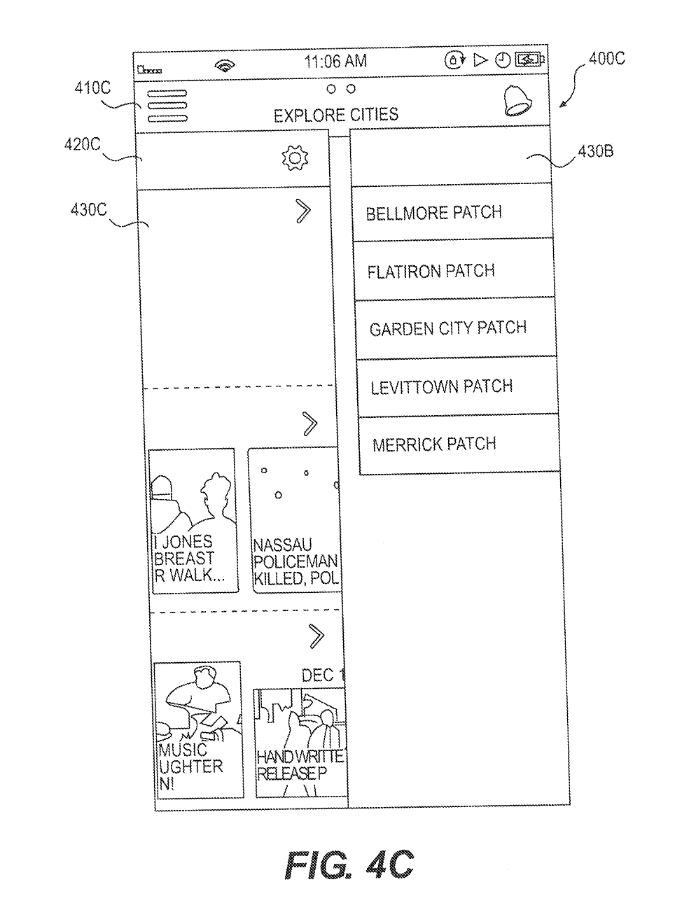

FIGS. 4A-4C illustrate exemplary content views for a foreground layer of navigation control provided via a graphical user interface based on the navigation control scheme of FIG. 2 and/or the navigation control scheme of FIG. 3. Specifically, FIG. 4A depicts an exemplary screenshot of an exemplary foreground view 400A of a mobile application. As described above, although the presently disclosed mobile application is described as being a user generated content program by which users may create and view content related to different categories, such as locations (e.g., cities, towns, neighborhoods, etc.), it should be appreciated that the mobile application may be related to creating and displaying any type of categorized content.

As shown in FIG. 4A, the exemplary foreground view 400A may include page navigation indicia 412A, which display and communicate to a user which of a plurality of foreground views 320 the user is currently viewing. In one embodiment, the foreground view 400A may include a user element 410A, which may be a menu icon and/or a slider by which a user may manipulate the foreground view 400A to expose a menu, such as the one or more menu elements 316 of a background view 310. As described above, such a menu or other background view 310 may be created and displayed based on an identity, content, or status of the currently displayed foreground view, in this case a foreground view associated with the content category, or location, “Palo Alto.” The foreground view 400A may include one or more content elements, such as weather indicia 420A of a weather status, a list of editor's picks 430A related to the displayed foreground view 400A, and one or more sets of content icons 432, 434, 436 relating to the foreground view associated with the content category. While the content icons 432, 434, 436 may each relate to different subject matter and display icons previewing such content, the underlying content may all be related to the content category of the displayed foreground view 400A (e.g., to “Palo Alto”).

In one embodiment, a user may manipulate the foreground view 400A, such as by tapping, swiping, or otherwise manipulating a touchscreen of the user device 102, to reveal the view controller array catalog 224, allowing selection between different view controller arrays 222 (i.e., between different foreground navigation stacks 220 of different content categories). Specifically, the user may view the foreground view 400B of FIG. 4B, which shows an embodiment of a view controller array catalog 224, by which a user may select among different foreground navigation stacks 220 of different content categories. In this case, as shown in FIG. 4B, the navigation indicia 412B may depict that the user is viewing a menu enabling the user to “Explore Cities,” the user may manipulate one or more of navigation bars 410B, 420B to swipe between the foreground views 220 shown as being available in the indicia 412B, and/or reveal one or more background views 210, such as a menu. In one embodiment, a user may “swipe” one or more of navigation bars 410B, 420B left and/or right to navigate between available foreground views, and may “swipe” one or more of navigation bars 410B, 420B downward to reveal one or more background views 210, such as a menu. In one embodiment, as shown in the intermediate view 400C FIG. 4C, as the user swipes one or more of navigation bars 410B, 420B left and/or right to navigate between available foreground views, the user may view both the navigation bars 410C, 420C and content views 430C consistent with navigation bars 410A, 420A and content previews/icons 432, 434, 436 of foreground view 400A, as well as the user elements 430B by which a user may select among view controller arrays 222.

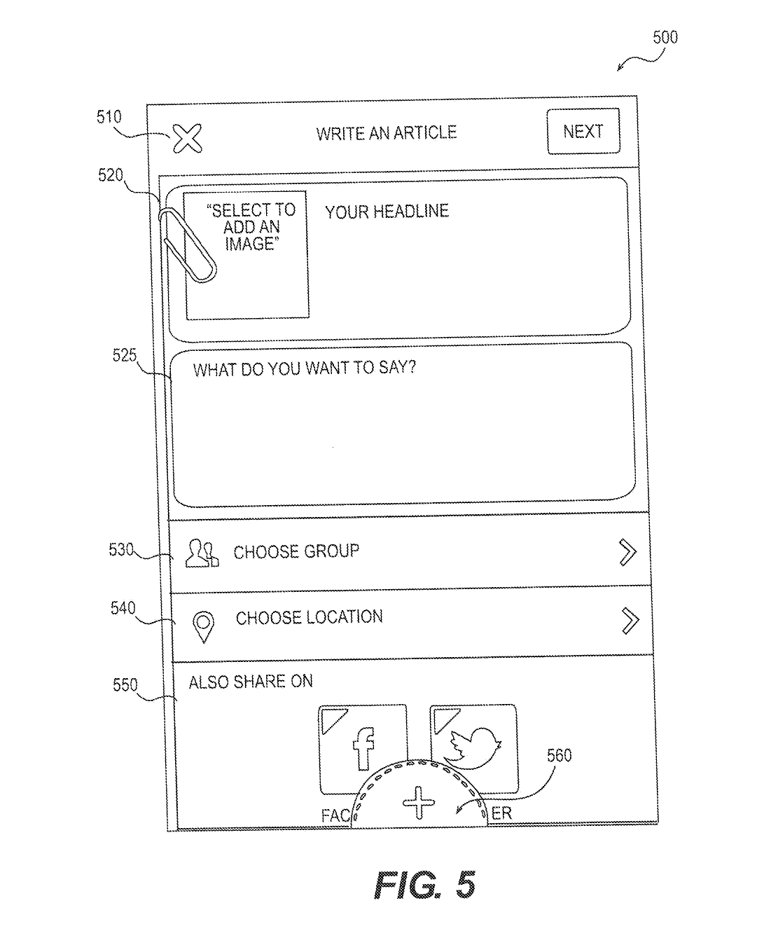

FIG. 4A also depicts an exemplary user element 460, which a user may tap or swipe to expose one or more additional user elements associated with create screens 314, by which a user may create an article, update, group, event, and/or media to be associated with the content category of the foreground view that was displayed when the user element 460 was manipulated. In one embodiment, when a user manipulates user element 460, create view controller array 214 may cause the display of one or more create screens 314, such as the exemplary create screen 500 depicted in FIG. 5. In one embodiment, as shown in FIG. 5, an exemplary create screen 500 may include a user element 510 to close the create screen 500, a user element 520 to upload user generated media (e.g., a photo or video) associated with a content category (e.g., location) of one of the foreground views, and a text field 525 in which a user may enter user generated text associated with a content category (e.g., location) of one of the foreground views. The create screen 500 may also include a user element 530 by which a user may select a group (e.g., consistent with a “Group” create screen 314) and a user element 540 by which a user may select a location (e.g., consistent with a “Find Location” create screen 314). In the exemplary create screen 500 of FIG. 5, the user may also manipulate toggle wheel 560 of sharing element 550 to share user generated content on one or more social networks.

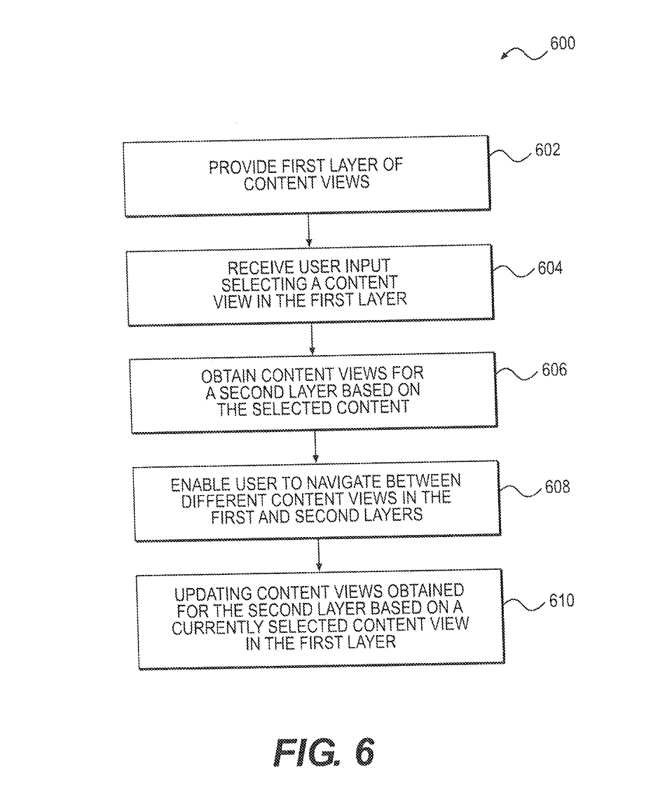

FIG. 6 is a process flowchart of an exemplary method 600 for providing navigation control across multiple layers of content views to be displayed via a GUI of a mobile application. Method 600 may include one or more of steps 602, 604, 606, 608 and 610. For ease of explanation, method 600 is described in the context of network environment 100 of FIG. 1, as described above, but method 600 is not intended to be limited thereto. Further, for ease of explanation, method 600 will be described in reference to a mobile application or client application executable at a mobile device (e.g., user device 102 of FIG. 1, as described above).

Method 600 may begin with providing a first layer of content views that are selectable by a user via a graphical user interface of an application executable at a mobile device (step 602). In an example, each of the content views in the first layer provides an initial or primary view of a particular content category. Such an initial view of the content category may be in the form of, for example, an introductory page or window control displaying various content items related to the particular category. The content view and content items may be displayed for a user within a content viewing area of the GUI or dedicated content viewer integrated with the GUI of the client application executable at the user's device. The GUI in this example may allow the user not only to view and select different content views and/or content items for display but also, to navigate between the currently displayed content view and other content views that may be in a “hidden” state or not visible in the view being displayed currently. For example, in one embodiment, the first layer may be a content view associated with a view controller array 222 of a foreground navigation stack 220.

Method 600 may include receiving a user input selecting a content view in the first layer (step 604). For example, the user may select a content preview or icon 432, 434, 436. Alternatively, or additionally, the user may select a foreground controller array 222 by manipulating a navigation bar 410A,420A, as indicated by indicia 412A, such as through a touchscreen of a user device 102, 104, 106.

Method 600 may include obtaining content views for a second layer based on the content selected in the first layer (step 606). Specifically, the method may include, obtaining content views for a second layer corresponding to the content view selected in the first layer, responsive to receiving user input selecting at least one of the content views in the first layer. Method 600 may include enabling the user to navigate between the content views in the first layer and corresponding content views in the second layer via the graphical user interface (step 608). The user may select different content views in the first layer or the second layer to be displayed at the mobile device via the graphical user interface. Finally, method 600 may include automatically updating content views obtained for the second layer with content views corresponding to a currently selected content view in the first layer (step 610).

One or more benefits of method 600 may include an improved user experience for navigating between different content views, particularly with respect to content views within different layers of content views with separate navigation controls. Moreover, users may navigate through a user application, allowing for multiple “layers” of navigation, which can interact with each other in meaningful ways to enhance the user experience. For example, the user is provided with multiple pathways through an application, rather than just linear traversal forward and backward through a set path of screens (in other words, a matrix in which each screen can lead to any other screen instead of a tree starting with the initial screen). The user may keep his or her place within multiple navigational flows using a mechanism embedded within the navigational system itself for the application that provides additional information to the user via revealing a screen in the bottom layer which is directly correlated with the content of the top layer. The disclosed systems and methods provide a unique user experience in which the user can interact with the various navigational flows in a tactile manner, pulling down a pad to dismiss it or to adjust its height or swiping a pad's binding to access the pad next to it.

In addition, the disclosed systems and methods enable screen designs that allow for various configurations of content on the top and bottom layers based on the available heights of the particular content view, as specified by the application design/code. Moreover, in one embodiment, the user may view and interact with partial content in the background view while also viewing and interacting with partial content in the foreground view. Lastly, bouncing animations may be incorporated into the raising and dropping of the foreground along with snapping animation features to enhance the skeuomorphic design and add a sense of playfulness to the user interface and user experience.

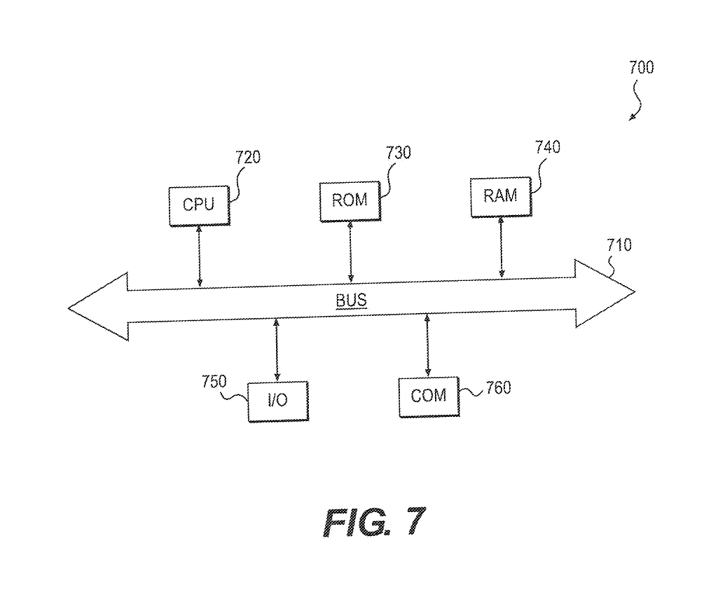

FIG. 7 is a block diagram of an exemplary computing system 700 in which embodiments of the present disclosure may be implemented. Computing system 700 may be included in one or more of the user devices 102, 104, 106, content distribution servers 110, 112, 114, and/or application server system 120, and configured to store and execute instructions for: (i) implementing one or more controllers of FIGS. 2 and 3, (ii) generating and updating displays associated with the exemplary screenshots of FIGS. 4A-4C and FIG. 5, and (iii) performing the exemplary method of FIG. 6. In one embodiment, computing system 700 may include a data communication interface for packet data communication 760. The platform may also include a central processing unit (CPU) 720, in the form of one or more processors, for executing program instructions. The platform typically includes an internal communication bus 710, program storage and data storage for various data files to be processed and/or communicated by the platform such as ROM 730 and RAM 740, although the server 700 often receives programming and data via a communications network (not shown). The hardware elements, operating systems and programming languages of such equipment are conventional in nature, and it is presumed that those skilled in the art are adequately familiar therewith. The server 700 also may include input and output ports 750 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

The presently disclosed applications, methods, devices, and systems may advantageously improve navigation flow between different content views, including those located at different layers of a multi-layer hierarchy of content views and navigation control between the different content views in each layer. Specifically, the navigation control scheme of the present disclosure, as described above, provide users of a mobile application or other type of client application executable at a mobile or desktop/personal computing device with greater flexibility and more options for navigating between different content views relative to conventional solutions.

While the presently disclosed sharing application, methods, devices, and systems are described with exemplary reference to applications for mobile applications, it should be appreciated that the presently disclosed embodiments may be applicable to any environment, such as a desktop or laptop computer, an automobile entertainment system, a home entertainment system, etc. Also, as previously noted, the presently disclosed embodiments may be applicable to any type of content, such as text content or video content.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing navigation control across multiple layers of content views within a mobile application, the method comprising:
providing a first layer of content views that are each selectable by a user for display via a graphical user interface of an application executable at a mobile device;
responsive to receiving user input selecting at least one of the content views in the first layer, obtaining content views for a second layer corresponding to the content view selected in the first layer; and
enabling the user to navigate between the content views in the first layer and corresponding content views in the second layer via the graphical user interface;
wherein the user selects different content views in the first layer or the second layer to be displayed at the mobile device via the graphical user interface, and content views obtained for the second layer are automatically updated with content views corresponding to a currently selected content view in the first layer.

2. The method of claim 1, further comprising:
displaying the currently selected content view or at least one of the corresponding content views in the second layer on a display screen of the mobile device based on user input received via the graphical user interface.

3. The method of claim 1, wherein the enabling step comprises:
providing navigation controls within each of the first and second layers for enabling the user to navigate between the content views of the respective first and second layers via the graphical user interface.

4. The method of claim 1, wherein the graphical user interface includes navigation controls enabling the user to select different content views of the first and second layers for display at the mobile device.

5. The method of claim 1, further comprising:
obtaining content items for the selected content view of the first layer; and
displaying the content items.

6. The method of claim 1, wherein the obtaining step comprises;
sending a request for the content items from the mobile device to a server via a communication network; and
upon receiving a response including the content items from the server, storing the content items to a memory of the mobile device.

7. The method of claim 1, further comprising:
enabling the user to select a content view;
retrieving the stored content items from memory for the second content layer; and
displaying the retrieved content items via the graphical user interface.

8. The method of claim 1, wherein the first layer of content views includes a plurality of content previews, each content preview being related to a subject matter topic.

9. The method of claim 1, wherein the first layer of content views includes a plurality of content previews, each content preview being related to a physical location including a neighborhood, city, or town.

10. The method of claim 9, wherein each content preview is related to a subject matter topic specific to the neighborhood, city, or town.

11. A system for providing navigation control across multiple layers of content views within a mobile application, the system including:
a data storage device storing instructions for providing navigation control across multiple layers of content views within a mobile application;
a processor configured to execute the instructions to perform a method including:
providing a first layer of content views that are each selectable by a user for display via a graphical user interface of an application executable at a mobile device;
responsive to receiving user input selecting at least one of the content views in the first layer, obtaining content views for a second layer corresponding to the content view selected in the first layer; and
enabling the user to navigate between the content views in the first layer and corresponding content views in the second layer via the graphical user interface;
wherein the user selects different content views in the first layer or the second layer to be displayed at the mobile device via the graphical user interface, and content views obtained for the second layer are automatically updated with content views corresponding to a currently selected content view in the first layer.

12. The system of claim 11, wherein the processor is further configured for:
displaying the currently selected content view or at least one of the corresponding content views in the second layer on a display screen of the mobile device based on user input received via the graphical user interface.

13. The system of claim 11, wherein the enabling step comprises:
providing navigation controls within each of the first and second layers for enabling the user to navigate between the content views of the respective first and second layers via the graphical user interface.

14. The system of claim 11, wherein the graphical user interface includes navigation controls enabling the user to select different content views of the first and second layers for display at the mobile device.

15. The system of claim 11, wherein the enabling step comprises:
obtaining content items for the selected content view of the first layer; and
displaying the content items.

16. The system of claim 11, wherein the obtaining step comprises:
sending a request for the content items from the mobile device to a server via a communication network; and
upon receiving a response including the content items from the server, storing the content items to a memory of the mobile device.

17. The system of claim 11, wherein the first layer of content views includes a plurality of content previews, each content preview being related to a subject matter topic.

18. The system of claim 11, wherein the first layer of content views includes a plurality of content previews, each content preview being related to a physical location including a neighborhood, city, or town.

19. The system of claim 11, wherein each content preview is related to a subject matter topic specific to the neighborhood, city, or town.

20. A computer readable medium storing instructions that, when executed by a computer, cause the computer to perform a method of providing navigation control across multiple layers of content views within a mobile application, the method including:
providing a first layer of content views that are each selectable by a user for display via a graphical user interface of an application executable at a mobile device;
responsive to receiving user input selecting at least one of the content views in the first layer, obtaining content views for a second layer corresponding to the content view selected in the first layer; and
enabling the user to navigate between the content views in the first layer and corresponding content views in the second layer via the graphical user interface;
wherein the user selects different content views in the first layer or the second layer to be displayed at the mobile device via the graphical user interface, and content views obtained for the second layer are automatically updated with content views corresponding to a currently selected content view in the first layer.
